(19) United States
(12) Patent Application Publication
(10) Pub. No.: US 2024/0163787 A1
(43) Pub. Date: May 16, 2024

(54) MULTI LINK DEVICE COOPERATION IN WIRELESS COMMUNICATION NETWORKS

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 18/506,945

(22) Filed: Nov. 10, 2023

Related U.S. Application Data
(60) Provisional application No. 63/589,105, filed on Oct. 10, 2023.
(60) Provisional application No. 63/383,444, filed on Nov. 11, 2022.

(30) Foreign Application Priority Data
Nov. 7, 2023 (CN) 202311473101.6

(51) Int. Cl. H04W 48/20; H04W 48/16

(52) U.S. Cl. CPC H04W 48/20; H04W 48/16

(57) ABSTRACT

A wireless communication network includes an access point (AP) device and a non-AP device. The AP device receives setup information from one or more external AP devices, including available links and buffered status of external AP devices. The AP devices generates data traffic to be transmitted to a station (STA) affiliated with a non-AP device via a link established between the AP device and the non-AP device. When detecting that the link is not available, the AP device selects one external AP device based on the setup information received from the one or more external AP devices and transfers the data traffic to the selected external AP device.

### CROSS REFERENCE TO RELATED APPLICATION

This application claims benefit of U.S. Provisional Application No. 63/589,105, filed on Oct. 10, 2023, and U.S. Provisional Application No. 63/383,444, filed on Nov. 11, 2022, in the United States Patent and Trademark Office, and China Patent Application No. 202311473101.6, filed on Nov. 7, 2023, in the China National Intellectual Property Administration, the entire contents of which are hereby incorporated by reference.

### TECHNICAL FIELD

The disclosure relates generally to wireless communication, and more particularly to, for example, but not limited to, multi-link operation for wireless communication networks.

### BACKGROUND

Wireless local area network (WLAN) devices are widely deployed in diverse environments to provide various communication services such as video, cloud access, broadcasting and offloading. Some of these environments have a lot of access points (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

However, there is a general need for devices and methods that improve reliability and data throughput in outdoor situations where devices are moving at medium or high speed. Additionally, there is a general need for improved WLAN to support real-time applications or delay-sensitive applications that require strict requirements on the delay and packet loss ratio. These applications include online gaming, real-time video streaming, virtual reality, and remote-control drones and vehicles.

The description set forth in the background section should not be assumed to be prior art merely because it is set forth in the background section. The background section may describe aspects or embodiments of the present disclosure.

### SUMMARY

One embodiment provides an access point (AP) device for facilitating wireless communication. The AP device comprises one or more APs affiliated with the AP device and one or more processors coupled to the one or more APs. The one or more processors are configured to cause receiving setup information from one or more external AP devices, the setup information including at least one available link of at least one AP affiliated with each of the one or more external AP devices. The one or more processors are configured to cause generating data traffic to be transmitted to a station (STA) affiliated with a non-AP device via a link established between the AP device and the non-AP device. The one or more processors are configured to cause detecting that the link is not available. The one or more processors are configured to cause selecting one external AP device among the one or more external AP devices based on the setup information received from the one or more external AP devices. The one or more processors are configured to cause transferring the data traffic to the selected external AP device.

In an embodiment, the one or more processors are further configured to cause receiving an acknowledgment in response to the transferred data traffic.

In an embodiment, the STA affiliated with the non-AP device is associated with an AP affiliated with the selected external AP device.

In an embodiment, the setup information further includes buffer status of the at least one AP affiliated with each of the one or more external AP devices.

In an embodiment, the setup information further includes a first list of STAs associated with the at least one AP affiliated with each of the one or more external AP devices.

In an embodiment, the selecting one external AP device is further based on the first list of STAs and a second list of STAs associated with the AP device.

In an embodiment, the acknowledgment is directly received from the non-AP device.

In an embodiment, the acknowledgment is received through the selected external AP device from the non-AP device.

In an embodiment, the acknowledgment is included in a group addressed frame indicating the AP device and the selected external AP device.

In an embodiment, the one or more processors are further configured to cause informing the selected external AP device of a primary channel of the link established between the AP device and the non-AP device.

In an embodiment, the one or more processors are further configured to cause transmitting, to the selected external AP device, an address or an identifier of the STA affiliated with the non-AP device.

One embodiment provides an access point (AP) device for facilitating wireless communication. The AP device comprises one or more APs affiliated with the AP device and one or more processors coupled to the one or more APs. The one or more processors are configured to cause transmitting setup information to an external AP device, the setup information including at least one available link of at least one AP affiliated with the AP device. The one or more processors are configured to cause receiving data traffic, from the external AP device, to be transmitted to a station (STA) affiliated with a non-AP device. The one or more processors are configured to cause forwarding the received data traffic to the STA affiliated with the non-AP device.

In an embodiment, the one or more processors are further configured to cause receiving an acknowledgment from the STA affiliated with the non-AP device, and forwarding the received acknowledgment to the external AP device.

In an embodiment, the STA affiliated with the non-AP device is associated with an AP affiliated with the AP device.

In an embodiment, the setup information further includes buffer status of the at least one AP affiliated with the AP device.

In an embodiment, the setup information further includes a first list of STAs associated with the at least one AP affiliated with the AP device.

In an embodiment, the acknowledgment is included in a group addressed frame indicating the AP device and the external AP device.

In an embodiment, the one or more processors are further configured to cause being informed, from the external AP device, of a primary channel of a link established between the external AP device and the non-AP device.

In an embodiment, the received data traffic is forwarded to the STA affiliated with the non-AP device through the primary channel informed from the external AP device.

In an embodiment, the one or more processors are further configured to cause receiving an address or an identifier of the STA affiliated with the non-AP device, and forwarding the received data traffic to the STA affiliated with the non-AP device using the address or the identifier of the STA affiliated with the non-AP device.

### BRIEF DESCRIPTION OF THE DRAWINGS

FIG. 1 illustrates an example of a wireless communication network in accordance with an embodiment.

FIG. 2 illustrates an example of a timing diagram of interframe space (IFS) relationships between wireless devices in accordance with an embodiment.

FIG. 3 illustrates examples of OFDM symbols and OFDMA symbols in accordance with an embodiment.

FIG. 4A illustrates an example of PPDU format in accordance with an embodiment. The PPDU may be used for SU and MU transmission.

FIG. 4B illustrates another example of PPDU format in accordance with an embodiment.

FIG. 5 illustrates a schematic diagram of an example of an electronic device in accordance with an embodiment.

FIG. 6 illustrates a schematic diagram of an example of a transmitter in accordance with an embodiment.

FIG. 7 illustrates a schematic diagram of an example of a receiver in accordance with an embodiment.

FIG. 8 illustrates a schematic diagram of an example of a multi-link operation in accordance with an embodiment.

FIG. 9 illustrates a schematic diagram of another example of a multi-link operation in accordance with an embodiment.

FIGS. 10A to 10D illustrate examples of a Multi-MLD operation when STAs of a non-AP MLD are associated with different AP MLDs in accordance with an embodiment.

FIGS. 11A to 11D illustrate examples of a Multi-MLD operation when STAs of a non-AP MLD are associated with APs of the same AP MLD.

FIG. 12 illustrates a flow chart of an example of a Multi-MLD operation performed by a Sharing AP MLD in accordance with an embodiment.

FIG. 13 illustrates a flow chart of an example of a Multi-MLD operation performed by a Shared AP MLD in accordance with an embodiment.

### DETAILED DESCRIPTION

The detailed description provided below is intended to describe various implementations and is not intended to represent the sole implementation. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description below has been described with reference to a WLAN system based on the Institute of Electrical and Electronics Engineers (IEEE) 802.11 wireless standards, including the current and future amendments. However, a person having ordinary skill in the art will readily recognize that the teachings herein are applicable to other network environments, such as cellular telecommunication networks and wired telecommunication networks.

In some embodiments, apparatuses or devices such as an AP station and a non-AP station may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. Additionally, the apparatus may include one or more other hardware or software elements such as a network interface and a display device.

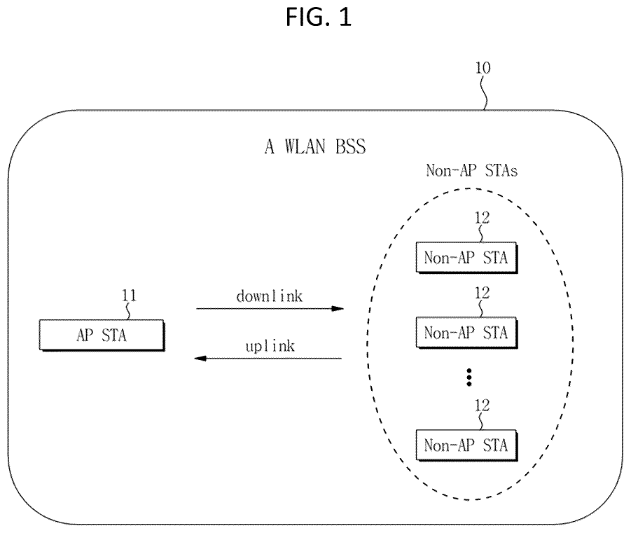

FIG. 1 illustrates an example of a wireless communication network in accordance with an embodiment. The wireless communication network may include a Basic Service Set (BSS) 10. The BSS 10 provides the basic organizational unit and includes a plurality of wireless devices which may be referred to as stations (STAs). In some implementations, the wireless device may include a plurality of STAs inside. The STA may be a logical entity that is a singly addressable instance of a medium access control (MAC) and physical layer (PHY) interface to the wireless medium (WM) according to IEEE 802.11 standards. The STA may be an access point (AP) STA and a non-AP STA. The AP STA may be an entity that contains one STA and provides access to the distribution system services via the wireless medium for associated STAs. The non-AP STA may be a STA that is not contained within an AP STA. The AP STA and the non-AP STA may be collectively called an STA. For simplicity of description, an AP STA may be referred to as an AP and a non-AP STA may be referred to as a STA or a station. The AP STA may comprise, be implemented as, or be included in a wireless device such as a centralized controller, a base station (BS), a node-B, a base transceiver system (BTS), a site controller, a network adapter, and a router. Similarly, the non-AP STA may comprise, be implemented as, or be included in a wireless communication device such as a terminal, a wireless transmit/receive unit (WTRU), a user equipment (UE), a mobile station (MS), a mobile terminal, a mobile subscriber unit, a laptop, a smartphone, a battery pack, and a non-mobile computing device.

Referring to FIG. 1, the BSS 10 in the wireless communication network may include an AP STA 11 and a plurality of non-AP STAs 12. The AP STA 11 may transmit information to a single station among the non-AP STAs 12 or may simultaneously transmit information to two or more stations among the non-AP STAs 12. The AP STA 11 may use, for the simultaneous transmission, Downlink (DL) multi-user (MU) transmission scheme such as DL OFDMA (Orthogonal Frequency Division Multiplexing Access) and DL MU-MIMO (Multi-User Multi-Input-Multi-Output). Similarly, each of the non-AP STAs 12 may individually transmit information to an AP STA or may simultaneously transmit information along with one or more other non-AP STAs 12. The non-AP STAs 12 may use, for the simultaneous transmission, Uplink (UL) MU transmission scheme such as UL OFDMA and UL MU-MIMO. In MU-MIMO transmission, a transmitting station may simultaneously transmit information to a plurality of receiving stations using one or more antennas over the same subcarriers. Different spatial streams may be used as the different resources in the MU-MIMO transmission. In OFDMA transmission, a transmitting station may simultaneously transmit information to a plurality of receiving stations over different groups of subcarriers. Different frequency (subcarriers) may be used as the different resource in the OFDMA transmission.

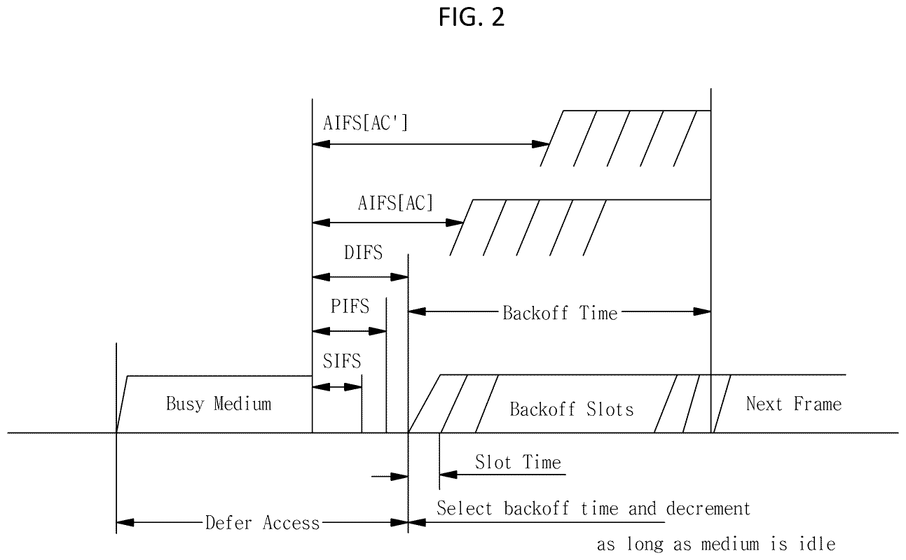

FIG. 2 illustrates an example of a timing diagram of interframe space (IFS) relationships between wireless devices in accordance with an embodiment. FIG. 2 depicts a CSMA (carrier sense multiple access)/CA (collision avoidance) frame transmission procedure to prevent collision between frames on a channel. These frames may include a data frame, a control frame, or a management frame that are exchanged among wireless devices.

The data frame may be used for transmission of data forwarded to a higher layer in a receiving station. In FIG. 2, access to the medium by wireless devices is deferred while the medium is busy until an IFS duration has elapsed. For example, a wireless device may transmit a data frame after completing a backoff period when a Distributed Coordination Function (DCF) IFS (DIFS) has expired. The management frame may be used for exchanging management information which is not forwarded to the higher layer in a receiving station. The management frame includes a beacon frame, an association request/response frame, disassociation frame, reassociation request/response frame, a probe request/response frame, and an authentication request/response frame and action frame. The control frame may be used for controlling access to the medium. The control frame includes a request to send (RTS) frame, a clear to send (CTS) frame, and an acknowledgment (ACK) frame, BlockAck request/response frame, NDP (Null Data PPDU) Announcement frame. If the control frame is not a response frame to another frame, the wireless device may transmit the control frame after performing backoff operation when the DIFS has elapsed. However, if the control frame is a response frame to another frame, the wireless device may transmit the control frame without performing backoff operation when a short IFS (SIFS) has elapsed. Furthermore, a QoS (Quality of Service) STA may transmit a frame after performing backoff operation when an arbitration IFS (AIFS) for access category (AC) (i.e., AIFS [AC]) has elapsed. In some embodiments, a point coordination function (PCF) enabled AP STA may transmit the frame after performing backoff operation when a PCF IFS (PIFS) has elapsed. The PIFS duration may be less than the DIFS duration, but greater than the SIFS duration.

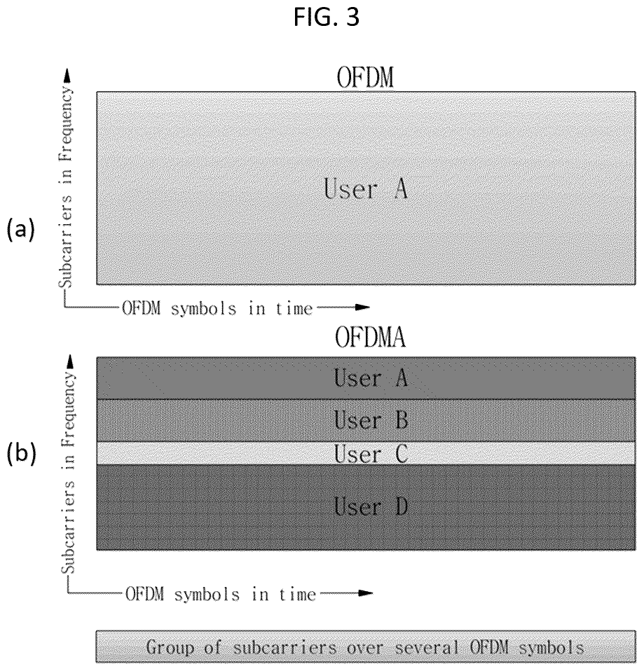

FIG. 3 illustrates examples of OFDM symbols and OFDMA symbols in accordance with an embodiment. In FIGS. 3(a) and 3(b), OFDM/OFDMA symbols are illustrated along the time dimension and subcarriers are illustrated along the frequency dimension.

The OFDMA was introduced in IEEE 802.11ax standard which is also known as High Efficiency (HE) WLAN. The OFDMA will be also used in next amendments to IEEE 802.11 standard such as Extreme High Throughput (EHT) WLAN. One or more STAs may be allowed to use one or more resource units (RUs) throughout operating bandwidth to transmit data at the same time. The RU may be a group of subcarriers as an allocation for subcarriers for transmission. In some aspects, non-AP STAs may be associated or non-associated with AP STA when transmitting response frames simultaneously in assigned RUs after a specific period of time such as SIFS. The SIFS may be the time from the end of the last symbol, or signal extension if present, of the previous frame to the beginning of the first symbol of the preamble of the subsequent frame.

The OFDMA is an OFDM-based multiple access scheme where different groups of subcarriers are allocated to different users, which allows simultaneous transmission to one or more users with high accurate synchronization for frequency orthogonality. The OFDMA allows users to be allocated to different groups of subcarriers in each PPDU (physical layer protocol data unit). An OFDM symbol in the OFDMA may include a plurality of subcarriers depending on the bandwidth of the PPDU. The difference between OFDM and OFDMA is illustrated in FIG. 3. As shown in FIG. 3(a), the OFDM symbol includes one single user (User A), while the OFDMA symbol includes a plurality of users (User A, User B, User C, and User D) and each user is assigned and allocated into different group of subcarriers as shown in FIG. 3(b).

In the case of UL MU transmission, the AP STA may control the medium by using more scheduled access mechanism which allows AP STAs and non-AP STAs to use OFDMA and MU-MIMO. A UL MU PPDU may be sent by non-AP STAs as a response to a trigger frame sent by the AP STA. The trigger frame may have information for receiving STAs and assign a single or multiple RU to the receiving STAs. It allows non-AP STAs to transmit OFDMA-based frame in the form of trigger-based (TB) PPDU (e.g., HE TB PPDU or EHT TB PPDU) where an operating bandwidth is segmented into a plurality of RUs and each RU serves as responses to the trigger frame. For simplicity of description, a single RU and a multiple RU (MRU) which are allocated into a non-AP STA may be collectively referred to as an RU. In some embodiments, the MRU may indicate the combination of two RUs.

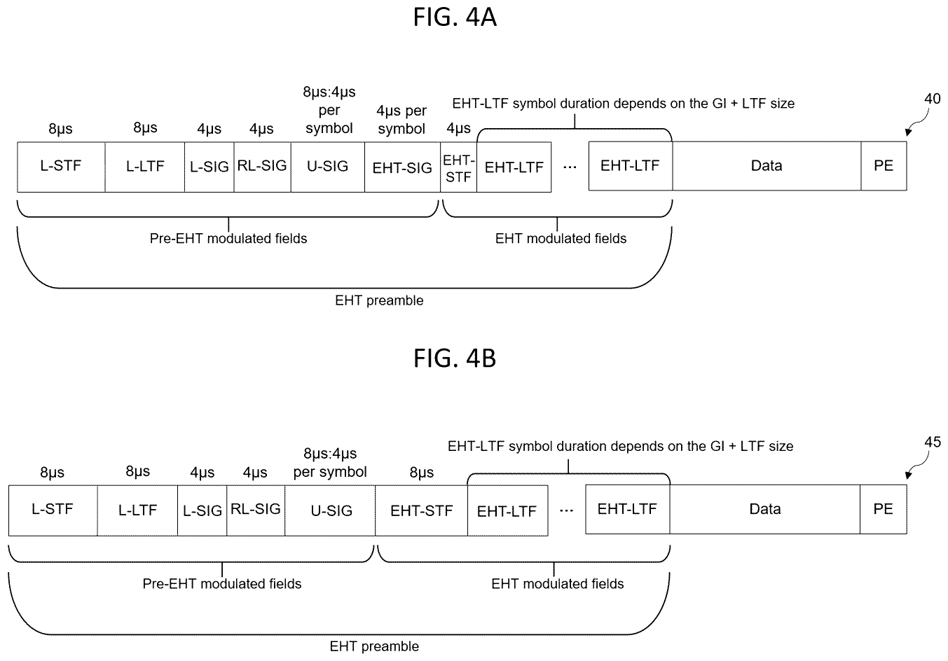

FIG. 4A illustrates an example of PPDU format in accordance with an embodiment. The PPDU may be used for SU and MU transmission. The PPDU may be used as EHT MU PPDU in accordance with IEEE 802.11be or may be used as a PPDU in accordance with any future amendments to the IEEE 802.11 standard.

Referring to FIG. 4A, the EHT MU PPDU 40 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a legacy short training field (L-STF), a legacy long training field (L-LTF), a legacy signal (L-SIG) field, a repeated legacy signal (RL-SIG) field, a universal signal (U-SIG) field and a EHT signal (EHT-SIG) field. The EHT modulated fields may include an EHT short training field (EHT-STF) and one or more EHT long training fields (EHT-LTFs).

The L-STF may be utilized for packet detection, automatic gain control (AGC) and coarse frequency-offset correction. The L-LTF may be utilized for channel estimation, fine frequency-offset correction, and symbol timing. The L-SIG field may provide information for communication such as data rate, a length related to the EHT PPDU 40. The RL-SIG field may be a repeat of the L-SIG field and may be used to differentiate an EHT PPDU from other PPDUs conforming to other IEEE 802.11 standards such as IEEE 802.11a/n/ac. The U-SIG field may provide information necessary for receiving STAs to interpret the EHT MU PPDU. The EHT-SIG may provide additional information to the U-SIG field for receiving STAs to interpret the EHT MU PPDU 40. For simplicity of description, the U-SIG field, the EHT-SIG field or both may be referred to herein as the SIG field. EHT-LTFs may enable receiving STAs to estimate the MIMO channel between a set of constellation mapper output and the receive chains. The data field may carry one or more PHY service data units (PSDUs). The PE field may provide additional receive processing time at the end of the EHT MU PPDU.

FIG. 4B illustrates another example of PPDU format in accordance with an embodiment. The PPDU in FIG. 4B may be used for SU and MU transmission. The PPDU 45 may be used as EHT TB (Trigger-based) PPDU in accordance with IEEE 802.11be or may be used as a PPDU conforming to any of future amendments to the IEEE 802.11 standard. In some embodiments, the EHT TB PPDU 45 is used for transmission by non-AP STA that is a response to a triggering frame from an AP STA.

As shown in FIG. 4B, the EHT TB PPDU 45 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a L-STF field, a L-LTF field, a L-SIG field, a RL-SIG field, a U-SIG field. The EHT modulated fields may include an EHT-STF and one or more EHT-LTFs. Unlike the EHT MU PPDU 40, the EHT-SIG may not be present in the EHT TB PPDU 45. Instead, the duration (8 us) of the EHT-STF of the EHT TB PPDU 45 may be twice the duration (4 us) of the EHT-STF of the EHT MU PPDU 40. Detailed description for the other fields in the EHT TB PPDU 45 will be omitted since the description for each field in the EHT MU PPDU 40 can be applied to each corresponding field of the EHT TB PPDU 45.

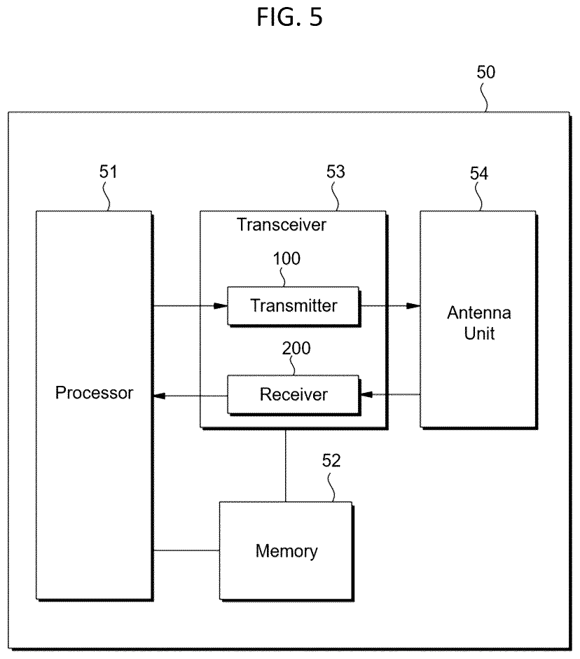

FIG. 5 illustrates a schematic diagram of an example of an electronic device in accordance with an embodiment. The electronic device 50 may be an example of the AP STA 11 or non-AP STA 12 shown in FIG. 1.

Referring to FIG. 5, the electronic device 50 may include a processor 51, a memory 52, a transceiver 53, and an antenna unit 54. The transceiver 53 may include a transmitter 100 and a receiver 200.

The processor 51 may perform medium access control (MAC) functions, PHY functions, RF functions, or a combination of some or all of the foregoing. In some embodiments, the processor 51 may comprise some or all of a transmitter 100 and a receiver 200. The processor 51 may be directly or indirectly coupled to the memory 52. In some embodiments, the processor 51 may include one or more processors.

The memory 52 may be non-transitory computer-readable recording medium storing instructions that, when executed by the processor 51, cause the electronic device 50 to perform operations, methods or procedures set forth in the present disclosure. In some embodiments, the memory 52 may store instructions that are needed by one or more of the processor 51, the transceiver 53, and other components of the electronic device 50. The memory may further store an operating system and applications. The memory 52 may comprise, be implemented as, or be included in a read-and-write memory, a read-only memory, a volatile memory, a non-volatile memory, or a combination of some or all of the foregoing.

The antenna unit 54 includes one or more physical antennas. When MIMO or MU-MIMO is used, the antenna unit 54 may include more than one physical antenna.

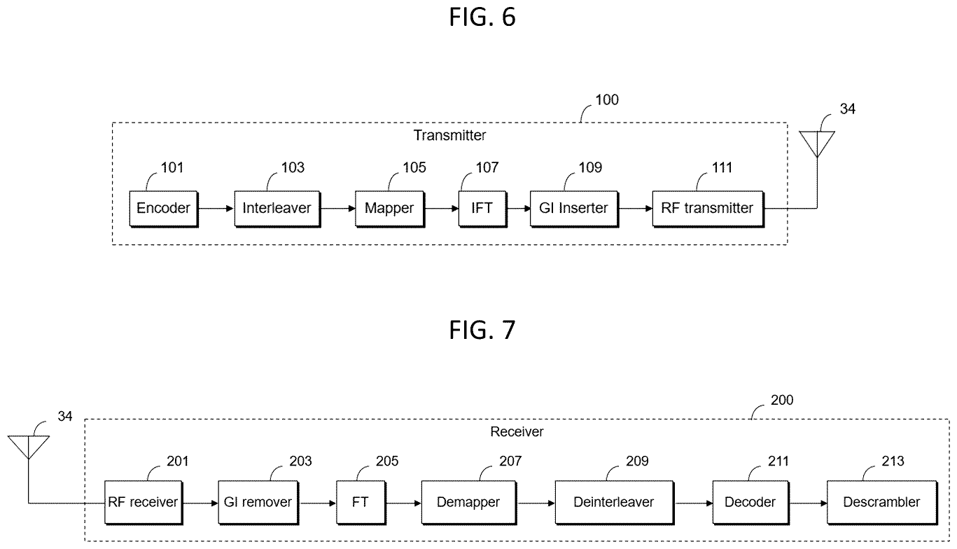

FIG. 6 illustrates a schematic diagram of an example of a transmitter in accordance with an embodiment. The transmitter in FIG. 6 may be an example of the transmitter illustrated in FIG. 5.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder. The interleaver 103 may interleave bits of encoded data from the encoder 101 to change the order of bits, and output interleaved data. In some embodiments, interleaving may be applied when BCC encoding is employed. The mapper 105 may map interleaved data into constellation points to generate a block of constellation points. If the LDPC encoding is used in the encoder 101, the mapper 105 may further perform LDPC tone mapping instead of the constellation mapping. The IFT 107 may convert the block of constellation points into a time domain block corresponding to a symbol by using an inverse discrete Fourier transform (IDFT) or an inverse fast Fourier transform (IFFT). The GI inserter 109 may prepend a GI to the symbol. The RF transmitter 111 may convert the symbols into an RF signal and transmit the RF signal via the antenna unit 34.

FIG. 7 illustrates a schematic diagram of an example of a receiver in accordance with an embodiment. The receiver in FIG. 7 may be an example of the receiver illustrated in FIG. 5.

Referring to FIG. 7, the receiver 200 in accordance with an embodiment may include a RF receiver 201, a GI remover 203, a Fourier transformer (FT) 205, a demapper 207, a deinterleaver 209, and a decoder 211. The RF receiver 201 may receive an RF signal via the antenna unit 34 and converts the RF signal into one or more symbols. The GI remover 203 may remove the GI from the symbol. The FT 205 may convert the symbol corresponding to a time domain block into a block of constellation points by using a discrete Fourier transform (DFT) or a fast Fourier transform (FFT) depending on implementation. The demapper 207 may demap the block of constellation points to demapped data bits. If the LDPC encoding is used, the demapper 207 may further perform LDPC tone demapping before the constellation demapping. The deinterleaver 209 may deinterleave demapped data bits to generate deinterleaved data bits. In some embodiments, deinterleaving may be applied when BCC encoding is used. The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data. The descrambler 213 may descramble the descrambled data bits based on a scrambler seed.

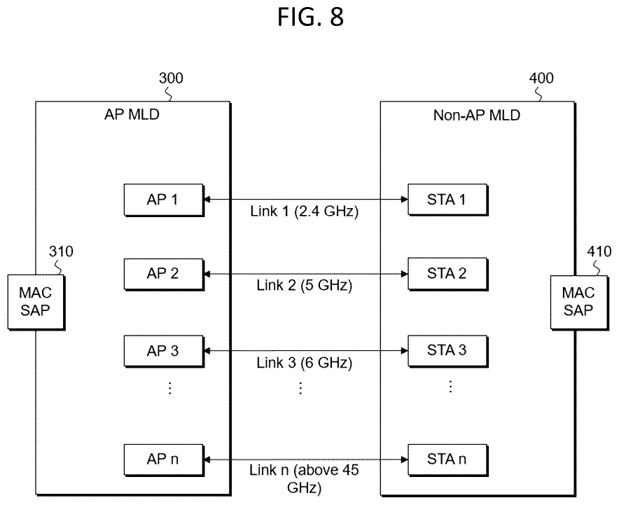

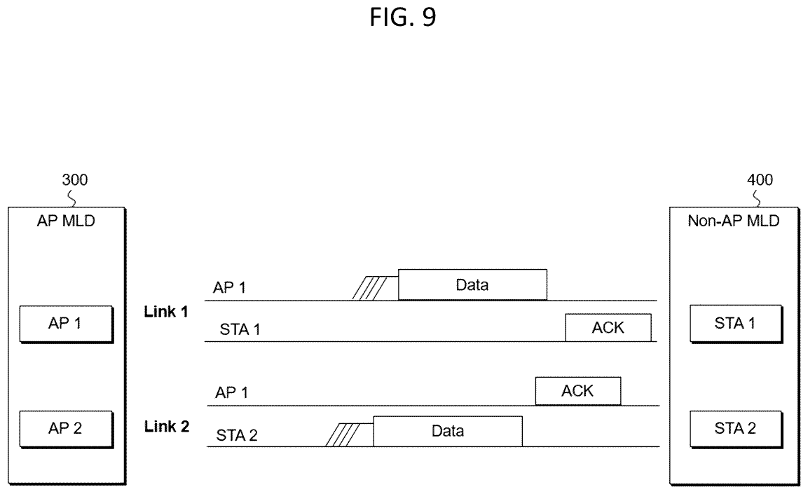

The IEEE 802.11be task group is currently developing next generation Wi-Fi standard to achieve higher data rates, lower latency, and more reliable connection to enhance user experience. One of the key features of the next generation Wi-Fi standard is multi-link operation (MLO). As most current APs and STAs incorporate dual-band or tri-band capabilities, the newly developed MLO feature enables packet-level link aggregation in the MAC layer across a plurality of different PHY links. By performing load balancing according to traffic requirements, MLO can achieve significantly higher throughput and lower latency for enhanced reliability in a heavily loaded network. The MLO capability enables a multi-link device (MLD) to incorporate multiple “affiliated” devices into the upper logical link control (LLC) layer. This allows for concurrent data transmission and reception across multiple channels in a single or multiple frequency bands including, such as 2.4 GHz, 5 GHz and 6 GHz. Hereinafter, the multi-link operation in accordance with an embodiment will be described with reference to FIG. 8 and FIG. 9.

FIG. 8 illustrates a schematic diagram of an example of a multi-link operation in accordance with an embodiment.

As shown in FIG. 8, the AP MLD 300 may be associated with the non-AP MLD 400 for the MLO. The AP MLD 300 and the non-AP MLD 400 may be an example of the electronic device 50 illustrated in FIG. 5.

The AP MLD 300 may include a plurality of affiliated APs (e.g., AP 1, AP 2, . . . , AP n) and an MAC service access point (MAC SAP) 310. Each affiliated AP may include a PHY interface to the wireless medium. Additionally, each affiliated AP may have its own MAC address corresponding to a lower MAC address. The MAC address of each affiliated AP within the AP MLD 300 may be different from MAC addresses of any other affiliated APs within the AP MLD 300. The AP MLD 300 may have an MLD MAC address corresponding to an upper MAC address. The affiliated APs may share the single MAC SAP 310 and communicate with a higher layer (Layer 3 or network layer) through the MAC SAP 310. In some embodiments, the affiliated APs may share a single IP address.

The non-AP MLD 400 may include a plurality of affiliated STAs (e.g., STA 1, STA 2, STA 3, . . . , STA n) and an MAC SAP 410. Each affiliated STA may include a PHY interface to the wireless medium. Furthermore, each affiliated STA may have its own MAC address corresponding to a lower MAC address. The MAC address of each affiliated STA within the non-AP MLD 400 may be different from MAC addresses of any other affiliated STAs 410 within the non-AP MLD 400. The non-AP MLD 400 may have a MLD MAC address corresponding to an upper MAC address. The affiliated STAs may share the single MAC SAP 410 and communicate with a higher layer (Layer 3 or network layer) through the MAC SAP 410. In some embodiments, the affiliated STAs may share a single IP address.

In some embodiments, each of the plurality of affiliated APs may be associated with a respective one of the plurality of affiliated STAs on its respective link. For example, AP 1 and STA 1 may establish Link 1, AP 2 and STA 2 may establish Link 2, and so on up to AP n and STA n, which may establish Link n. Each of the plurality of links (Link 1, Link 2, . . . , Link n) may be associated with a respective one of a plurality of frequency bands, for example, including one or more of 2.4 GHz, 5 GHz, 6 GHz, and a millimeter band. The millimeter band may refer to a band of frequency from 30 to 300 GHz. Radio waves in the millimeter band have wavelengths from ten to one millimeter. For convenience of description, the millimeter band may refer to a band of frequency above 45 GHz in this disclosure. In the example of FIG. 8, Link 1, Link 2, Link 3, and Link n may operate on 2.4 GHz, 5 GHz, 6 GHz, and above 45 GHz, respectively.

An Electronic device or a wireless device may connect to a single link and switch the link between 2.4 GHz, 5 GHz and 6 GHz bands. However, there may be a switching overhead or delay of up to 100 ms when the device switches their link. Therefore, the multi-link operation may be highly desirable for real-time applications, such as video calls, wireless VR headsets, cloud gaming and other latency-sensitive applications, because MLDs can maintain two or more links.

FIG. 9 illustrates a schematic diagram of another example of a multi-link operation in accordance with an embodiment. In FIG. 9, the AP MLD 300 and the non-AP MLD 400 may be examples of the electronic device 50 illustrated in FIG. 5. The AP MLD 300 may include AP 1 and AP 2 and the non-AP MLD 400 may include STA 1 and STA 2. The Link 1 may be established between AP 1 and STA 2, and the Link 2 may be established between AP 2 and STA 2.

In this example, the AP MLD 300 and the non-AP MLD 400 may operate over a simultaneous transmit and receive (STR) link pair and contend for access to the wireless medium and subsequent frame exchanges between two MLDs on those links. After the AP MLD 300 has performed a multi-link setup with the non-AP MLD 400 to set up Link 1 and Link 2 successfully and the links are enabled, then AP 2 may receive data frame from STA 2 on Link 2, while AP 1 contends for the wireless medium and then transmits data frame to STA 1 on Link 1 after the AP 1 obtains a transmission opportunity (TXOP).

IEEE 802.11be draft specification defines various channel access methods based on two transmission modes: asynchronous transmission mode and synchronous transmission mode. Under asynchronous transmission mode, MLDs may asynchronously transmit frames across multiple links without aligning starting times of frames as shown in FIG. 9. In contrast, synchronous transmission mode aligns the starting times for frame transmissions across the links. In both modes, the links may have their own primary channel and parameters, such as Modulation and Coding Scheme (MCS) and Enhanced Distributed Channel Access (EDCA).

A multi-AP operation may be one of the important technologies that may be discussed for future amendments to IEEE 802.11 standard. In the multi-AP operation, multiple APs cooperate to transmit and receive data frame to/from a STA or a non-AP MLD. This disclosure provides methods and mechanisms that utilize both the multi-AP operation and the multi-link operation when both AP MLDs and non-AP MLDs participating in the multi-AP operation support the multi-link operation. This combined operation may be referred to as a ‘Multi-MLD operation’ in this disclosure. In the Multi-MLD operation, an AP MLD may exchange frames with a non-AP MLD by cooperating with one or more other AP MLDs, for example, when the buffer at the AP MLD becomes full or crowded. This disclosure provides the Multi-MLD operation that improves the latency caused by buffer congestion at an AP MLD.

In this disclosure, a Sharing AP MLD may refer to an AP MLD that controls the Multi-MLD operation in an environment where there are one or more other AP MLDs in the vicinity of the Sharing AP MLD. On the other hand, a Shared AP MLD may refer to an AP MLD that can participate in the Multi-MLD operation under the direction of the Sharing AP MLD in the Multi-MLD environment. Furthermore, a Share AP may be referred to as an AP affiliated with the Shared AP MLD. A STA MLD or a non-AP MLD may refer to an MLD that transmits and receives data frame with a Sharing AP MLD or a Shared AP MLD in the Multi-MLD operation.

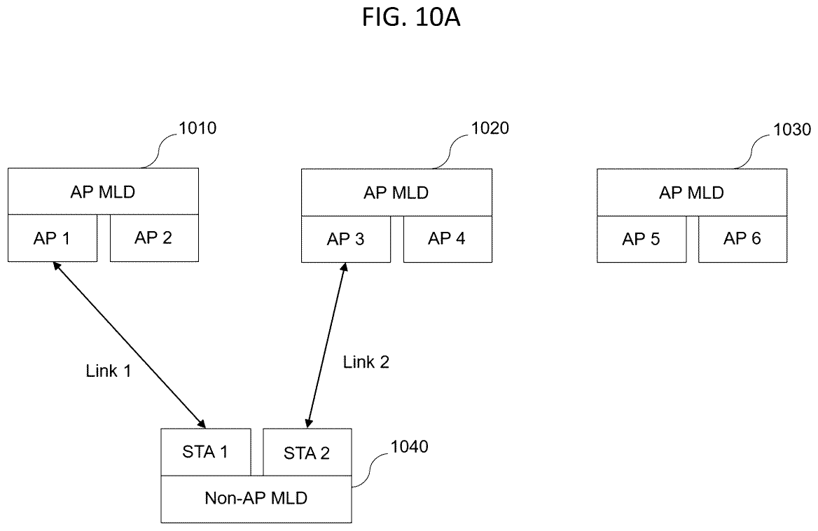

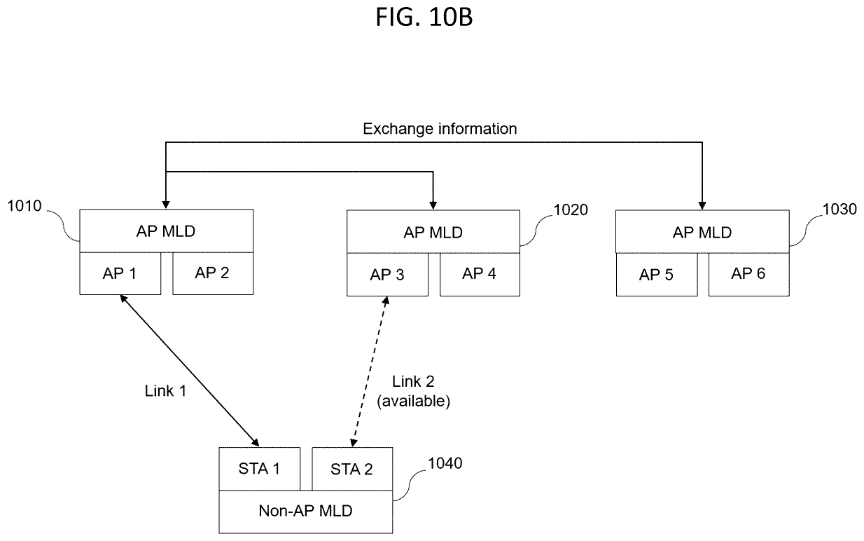

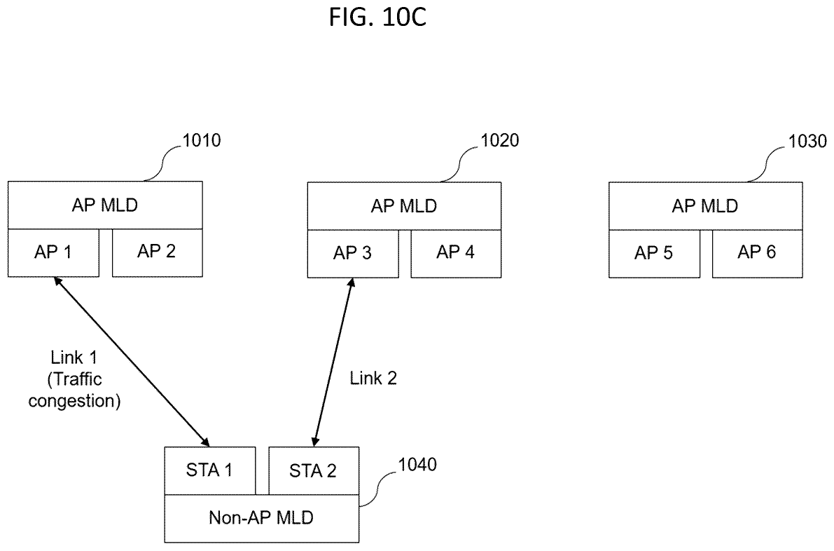

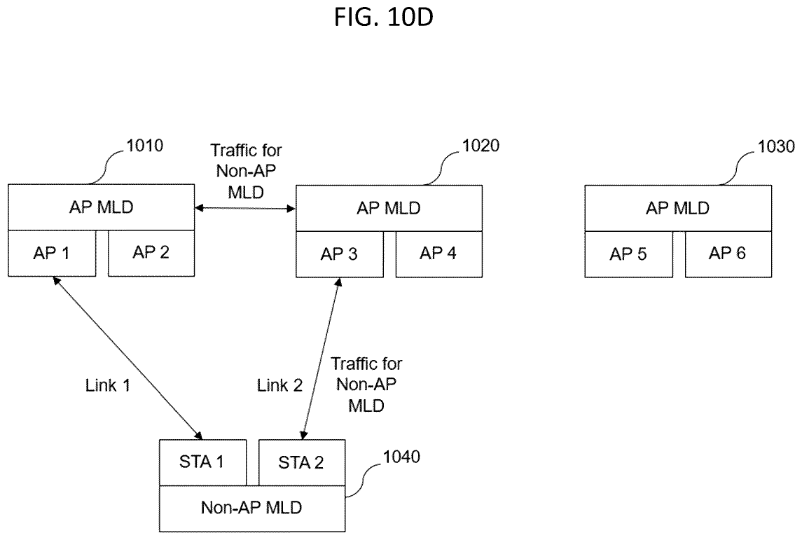

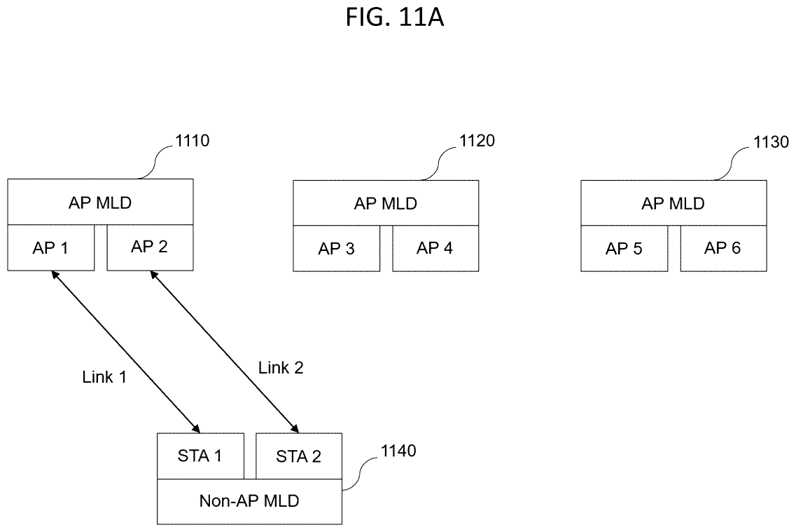

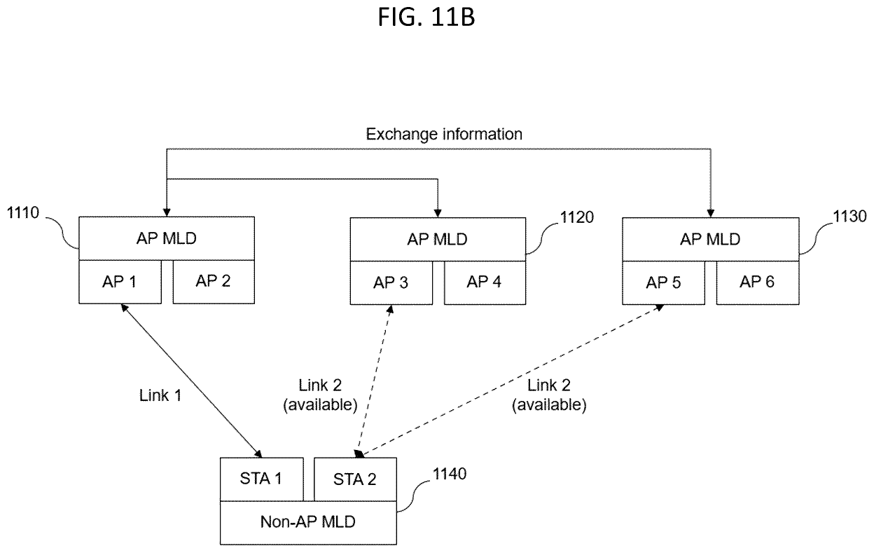

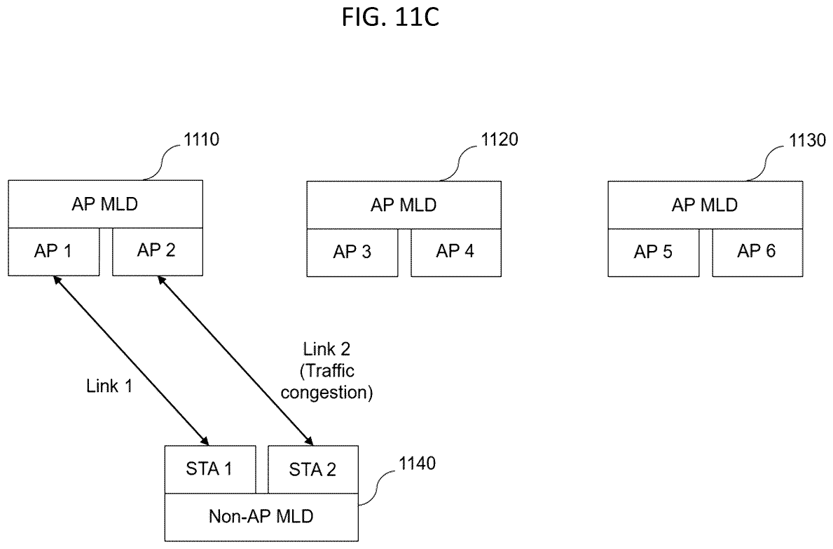

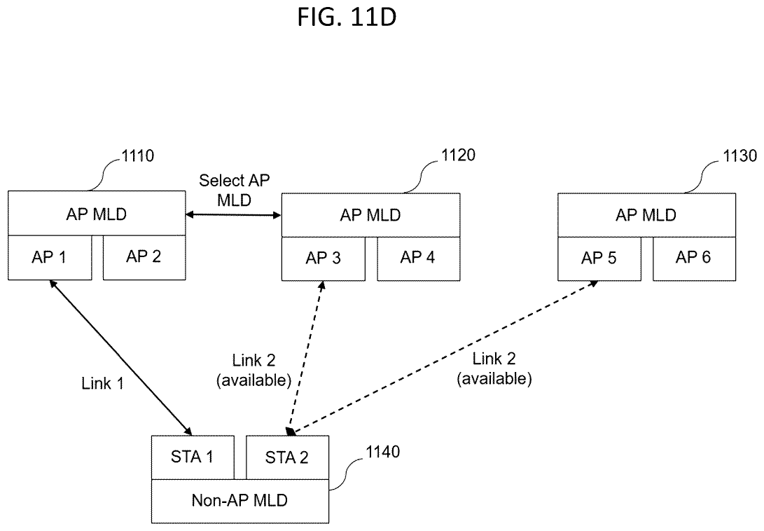

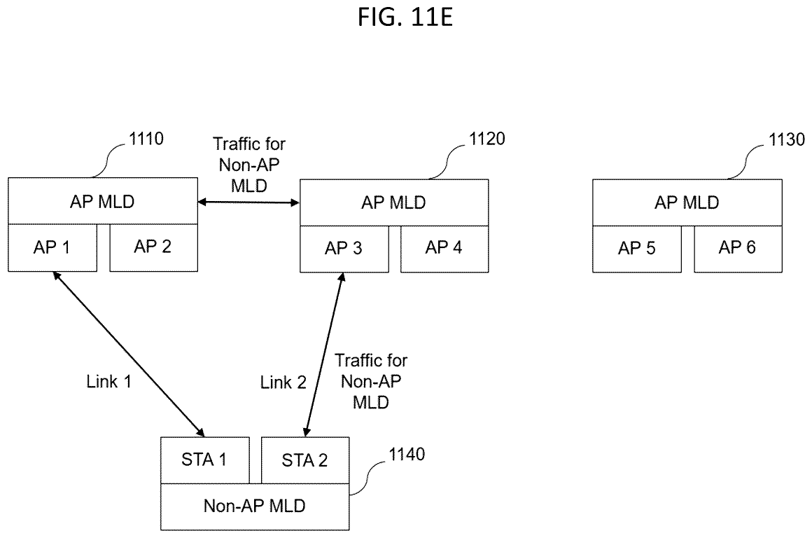

In this disclosure, the following two exemplary scenarios will be considered for the convenience of the description: i) the first scenario involves is that STAs affiliated with a non-AP MLD are associated with APs affiliated with different AP MLDs, and ii) the second scenario is that STAs affiliated with a non-AP MLD are associated with APs affiliated with same AP MLDs. The first scenario will be further explained in detail with reference to FIGS. 10A to 10D, while the second scenario will be similarly detailed with reference to FIGS. 11A to 11E.

FIGS. 10A to 10D illustrate examples of a Multi-MLD operation when STAs of a non-AP MLD are associated with different AP MLDs in accordance with an embodiment.

In FIG. 10A to 10D, an AP MLD 1010 is a Sharing AP MLD, and an AP MLD 1020 and an AP MLD 1030 are Shared AP MLDs. Thus, AP MLD 1010 may control the AP MLD 1020 and the AP MLD 1030 for the Multi-MLD operation. The AP MLD 1010 may have two affiliated APs (e.g., AP 1 and AP 2). The AP MLD 1020 may also have two affiliated APs (e.g., AP 3 and AP 4). Similarly, AP MLD 1030 may have two affiliated APs (e.g., AP 5 and AP 6). Furthermore, a non-AP MLD 1040 may have two affiliated STAs (e.g., STA 1 and STA 2).

FIG. 10A shows a topology to describe the Multi-MLD operation when STAs of a non-AP MLD are associated with different AP MLDs. In FIG. 10A, the STA 1 affiliated with the non-AP MLD 1040 may establish Link 1 with the AP 1 affiliated with the AP MLD 1010. On the other hand, the STA 2 affiliated with the non-AP MLD 1040 may establish Link 2 with the AP 3 affiliated with the AP MLD 1020. Thus, the STA 1 of the non-AP MLD 1040 may be associated with the AP 1 of the AP MLD 1010, while the STA 2 of the non-AP MLD 1040 may be associated with the AP 3 of the AP MLD 1020. As shown in FIG. 10A, STA 1 and STA 2 of non-AP MLD 1040 are associated with AP 1 and AP 3, respectively, which are affiliated with different AP MLDs 1010 and 1020.

FIG. 10B shows an example of a Multi-MLD operation setup procedure in accordance with an embodiment.

Referring to FIG. 10B, the Sharing AP MLD 1010 may receive information of Shared APs required for the Multi-MLD setup process. This information may include, but not limited to, i) available links and operating bandwidth of Share APs, ii) buffer status on Shared APs, and iii) a list of STAs which are associated with Shared APs. In FIG. 10B, the Sharing AP MLD 1010 may receive this information from Shared AP MLD 1020 and Shared AP MLD 1030. For example, the Shared AP MLD 1020 may have an available Link 2 between AP 3 and STA 2 which operates on 5 GHz frequency band. As such, the Sharing AP MLD 1010 may receive information from the AP MLD 1020 with regard to i) available link (i.e., Link 2) and operating bandwidth (i.e., 5 GHz) of AP 3, ii) buffer status on AP 3, and iii) the list of STAs (i.e., STA 2) associated with AP MLD 1020.

The Sharing AP MLD 1010 may identify which AP MLD can participate in the Multi-MLD operation as a Shared AP MLD, based on i) the available links and operating bandwidths of Shared APs, ii) buffer status on Shared APs, and iii) a list of STAs which are associated with Shared APs. In particular, the Sharing AP MLD 1010 may determine which Shared AP has affordable buffer status for the Multi-MLD operation based on buffer status on each Shared AP. Furthermore, the Sharing AP MLD 1010 may identify i) a first list of STAs that are associated with APs affiliated with Shared AP MLDs, and ii) a second list of STAs that are associated with APs affiliated with the Sharing AP MLD 1010 itself. The Sharing AP MLD 1010 may compare these two lists. Based on the comparison of two lists, the Sharing AP MLD 1010 may identify which STAs associated with Shared APs are affiliated with the non-AP MLD 1040 that is also associated with the Sharing AP MLD 1010. In FIG. 10B, the Sharing AP MLD 1010 may identify that the STA 2 is associated with the AP 3 of the Shared AP MLD 1020 which has affordable buffer status, based on information received from the Shared AP MLD 1020. Accordingly, the AP MLD 1010 may finally determine that AP MLD 1020 may participate in the Multi-MLD operation.

FIG. 10C shows an example that requires the Multi-MLD operation in accordance with an embodiment. Referring to FIG. 10C, the STA1 and the AP 1 establish Link 1 and are associated with each other, while the STA 2 and the AP 3 establish Link 2 and are associated with each other. In this scenario, the Sharing AP MLD 1010 may generate data traffic to be transmitted to the STA 1 of non-AP MLD 1040 through AP 1. However, the Link 1 between AP 1 and STA 1 may be congested to handle the traffic due to various implementation dependent reasons, whereas the Link 2 between AP 3 and STA 2 may be affordable for transmission of the data traffic. This situation may exemplify the need for the Multi-MLD operation.

FID. 10D shows an example of the Multi-MLD operation based on the example of FIG. 10C. Referring to FIG. 10D, the Sharing AP MLD 1010 may transfer all or part of data traffic, which is supposed to be sent to the STA 1 of non-AP MLD 1040 through the AP 1, to the Shared AP MLD 1020 using a connection or a channel between the Sharing AP MLD 1010 and the Shared AP MLD 1020. The connection or channel may be a pre-established link between the two MLDs. Additionally, the Sharing AP MLD 1010 may instruct the Shared AP MLD 1020 to send the transferred data traffic to the STA 2 of the non-AP MLD 1040 via Link 2. The STA 2 is affiliated with the same non-AP MLD 1040 as STA 1. In response to the instruction from the Sharing AP MLD 1010, the AP 3 of the Shared AP MLD 1020 may transmit the transferred data traffic to the STA 2 of non-AP MLD 1040.

When the STA 2 of non-AP MLD 1040 receives the transferred data traffic from the AP 3 of Shared AP MLD 1020, the non-AP MLD 1040 may send acknowledgment (ACK) or block acknowledgment (BlockAck) to the Sharing AP MLD 1010. In an embodiment, the non-AP MLD 1040 may transmit ACK or BlockAck to the Sharing AP MLD 1010 through the STA 1 of non-AP MLD 1040 which is associated with AP 1 of the Sharing AP MLD 1010 via Link 1. In another embodiment, the non-AP MLD 1040 may transmit ACK or BlockAck to the Shared AP MLD 1020 through the STA 2 that is associated with the AP 3 via Link 2. Subsequently, the Shared AP MLD 1020 may forward the ACK or BlockAck to the Sharing AP MLD 1010. In another embodiment, the non-AP MLD 1040 may transmit ACK or BlockAck directly to both Sharing AP MLD 1010 and Shard AP MLD 1020 via Link 1 and Link 2, respectively. In some implementations, the non-AP MLD 1040 may transmit ACK or BlockAck directly to both Sharing AP MLD 1010 and Shard AP MLD 1020 using a grouping address which indicates both Sharing AP MLD 1010 and Shard AP MLD 1020.

FIGS. 11A to 11D illustrate examples of a Multi-MLD operation when STAs of a non-AP MLD are associated with APs of the same AP MLD.

In FIGS. 11A to 11D, an AP MLD 1110 is a Sharing AP MLD, and an AP MLD 1120 and an AP MLD 1130 are Shared AP MLDs. Thus, AP MLD 1110 may control the AP MLD 1120 and the AP MLD 1130 for the Multi-MLD operation. The AP MLD 1110 may have two affiliated APs (e.g., AP 1 and AP 2). The AP MLD 1120 may also have two affiliated APs (e.g., AP 3 and AP 4). Similarly, the AP MLD 1130 may have two affiliated APs (e.g., AP 5 and AP 6). Additionally, the non-AP MLD 1140 may have two affiliated STAs (STA 1 and STA 2).

FIG. 11A shows a topology to describe the Multi-MLD operation when STAs of a non-AP MLD are associated with the same AP MLD. In FIG. 11A, the STA 1 affiliated with the non-AP MLD 1140 may establish Link 1 with AP 1 affiliated with AP MLD 1110. Similarly, the STA 2 affiliated with the non-AP MLD 1140 may establish Link 2 with the AP 2 affiliated with the AP MLD 1110. Thus, STA 1 and STA 2 of non-AP MLD 1140 may be associated with AP 1 and AP 2 of the same AP MLD 1110, respectively.

FIG. 11B shows an example of a Multi-MLD operation setup procedure in accordance with an embodiment.

Referring to FIG. 11B, the Sharing AP MLD 1110 may receive information of Shared APs required to set up the Multi-MLD operation. This information may include, but not limited to, i) available links and operating bandwidth of Shared APs, ii) buffer status on Shared APs, and iii) a list of STAs which are associated with Shared APs. In FIG. 11B, the Sharing AP MLD 1110 may receive this information from Shared AP MLD 1120 and Shared AP MLD 1130. For example, the Shared AP MLD 1120 may have an available Link 2 between AP 3 and STA 2 which operates on 5 GHz. The Shared AP MLD 1130 may have an available Link 2 between AP 5 and STA 2 which operates on 5 GHz. Accordingly, the Sharing AP MLD 1110 may receive information from AP MLD 1120 in regard to i) available link (i.e., Link 2) and operating bandwidth (i.e., 5 GHz) of AP 3, ii) buffer status on AP 3, and iii) the list of STAs (i.e., STA 2) associated with AP MLD 1120. Similarly, the Sharing AP MLD 1110 may receive information from AP MLD 1130 in regard to i) available link (i.e., Link 2) and operating bandwidth (i.e., 5 GHz) of AP 5, ii) buffer status on AP 5, and iii) the list of STAs (i.e., STA 2) associated with AP MLD 1130.

The Sharing AP MLD 1110 may identify which AP MLD can participate in the Multi-MLD operation as a Shared AP MLD based on i) available links and operating bandwidth of Shared APs, ii) buffer status on Shared APs, and iii) a list of STAs which are associated with Shared APs. In particular, the Sharing AP MLD 1110 may determine which Shared AP has affordable buffer status for the Multi-MLD operation based on buffer status information received from each Shared AP. As such, the Sharing AP MLD 1110 may instruct a Shared AP MLD with affordable buffer status to participate in the Multi-MLD operation. Furthermore, the Sharing AP MLD 1110 may identify i) a first list of STAs that are associated with APs affiliated with Share AP MLD 1120 or Shared AP MLD 1130, and ii) a second list of STAs that are associated with APs affiliated with Sharing AP MLD 1110 itself. Based on information received from the AP MLD 1120 and the AP MLD 1130, the Sharing AP MLD 1110 may identify which STAs associated with Shared APs are affiliated with the same non-AP MLD 1040. In FIG. 11B, the Sharing AP MLD 1110 may identify that the STA 2 is associated with the AP 3 of the Shared AP MLD 1120 and the AP 5 of the Shared AP MLD 1130 based on information received from the Shared AP MLD 1120 and the Shared AP MLD 1130.

FIG. 11C shows another example that requires the Multi-MLD operation in accordance with an embodiment. Referring to FIG. 11C, the STA 1 and the AP 1 establish Link 1 and are associated with each other, while the STA 2 and the AP 2 establish Link 2 and are associated with each other. In this scenario, the Sharing AP MLD 1110 may generate data traffic to be transmitted to non-AP MLD 1140 through AP 1 and AP 2. However, a specific link among enabled links between AP MLD 1110 and non-AP MLD 1140 may be congested to handle traffic due to various implementation dependent reasons. For example, the Link 2 between AP 2 and STA 2 may be congested to handle traffic, whereas the Link 1 between AP 1 and STA 1 may be affordable. This situation may exemplify the need for the Multi-MLD operation.

FIG. 11D shows an example that a Sharing AP MLD selects a Shared AP MLD to transfer data traffic in the situation of FIG. 11C.

Referring to FIG. 11D, the Sharing AP MLD 1110 may identify Shared AP MLDs that have the affordable link to transmit data traffic to STA 2 of the non-AP MLD 1140 on behalf of AP 2. The Sharing AP MLD 1110 may select a Shared AP MLD with the best buffer status among available Shared AP MLDs 1110 and 1120 that support available links to the STA 2 of non-AP MLD 1140. In this example, the Sharing AP MLD 1110 may select the Shared AP MLD 1120. The Sharing AP MLD 1110 may inform the Shared AP MLD 1120 of a primary channel of Link 2 between AP 2 and STA 2 which has been used for transmission of data to STA 2 of non-AP MLD 1140. Therefore, the AP 3 may immediately transmit traffic data to STA 2 without performing additional association process between the AP 3 and STA 2. Additionally, the Sharing AP MLD 1110 may transmit the MAC address or the AID of STA 2 of non-AP MLD 1140 to the Shared AP MLD 1120, which enables the STA 2 to successfully decode data traffic transmitted by the Shared AP MLD 1120. Thus, the AP 3 of Shared AP MLD 1120 may transmit data traffic, which was supposed to be transmitted through AP 2, to STA 2 of non-AP MLD 1140 on the primary channel of Link 2 between AP 2 and STA 2 using the MAC address or the AID of STA 2.

FIG. 11E shows an example of the Multi-MLD operation based on the example of FIG. 11D. Referring to FIG. 11E, the Sharing AP MLD 1110 may transfer all or part of data traffic, which are supposed to be sent to STA 2 through AP 2, to the Shared AP MLD 1120 using a connection or a channel between the Sharing AP MLD 1110 and the Shared AP MLD 1120. The connection or the channel may be a pre-established link between the two MLDs. Additionally, the Sharing AP MLD 1110 may instruct the Shared AP MLD 1120 to send the transferred data traffic to the STA 2 of non-AP MLD 1140 via Link 2 between AP 3 and STA 2. Subsequently, the Shared AP MLD 1120 may transmit the transferred data traffic to the STA 2 via Link 2 between AP 3 and STA 2. Accordingly, the congested link of Sharing AP MLD 1110 may be alleviated by the Shared AP MLD 1120 that transmits the data traffic to STA 2, which is supposed to be sent by AP 1, on behalf of Sharing AP MLD 1110.

When the STA 2 of non-AP MLD 1140 receives the transferred data traffic from AP 3 of the Shared AP MLD 1120, the non-AP MLD 1140 may send ACK or BlockAck to the Sharing AP MLD 1110. In an embodiment, the non-AP MLD 1140 may transmit ACK or BlockAck to the Sharing AP MLD 1110 through STA 1 of non-AP MLD 1140 which is associated with AP 1 of Sharing AP MLD 1010 via Link 1. In another embodiment, non-AP MLD 1140 may transmit ACK or BlockAck through STA 2 of non-AP MLD 1140 which is associated with the AP 3 of Shared AP MLD 1120, and then the Shared AP MLD 1120 may forward the ACK or BlockAck to the Sharing AP MLD 1110. In another embodiment, the non-AP MLD 1140 may transmit ACK or BlockAck directly to both the Sharing AP MLD 1110 and the Shard AP MLD 1120. In some implementations, the non-AP MLD 1140 may transmit ACK or BlockAck directly to both Sharing AP MLD 1110 and Shard AP MLD 1120 using a grouping address which indicates Sharing AP MLD 1110 and Shard AP MLD 1120.

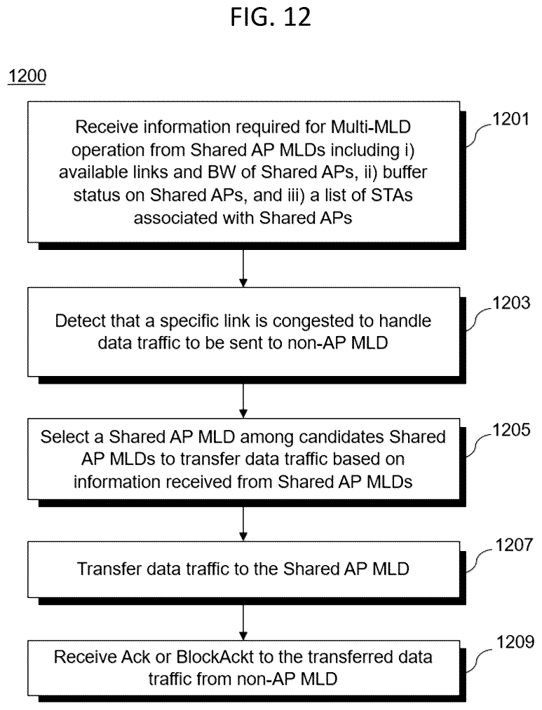

FIG. 12 illustrates a flow chart of an example of a Multi-MLD operation performed by a Sharing AP MLD in accordance with an embodiment. For explanatory and illustration purposes, the example process 1200 may be performed by the Sharing AP MLDs 1010 and 1110. The blocks of the example process 1200 are described herein as occurring in serial or linearly. However, multiple blocks of the example process 1200 may occur in parallel. In addition, the blocks of the example process 1200 need not be performed in the order shown and/or one or more of the blocks/actions of the example process 1200 need not be performed.

At S1201, a Sharing AP MLD may receive information required for Multi-MLD operation set up process from Shared AP MLDs. This information may include, but not limited to, i) available links and operating bandwidth of Share APs, ii) buffer status on Shared APs, and iii) a list of STAs which are associated with Shared APs.

At S1203, the Sharing AP MLD may detect that a specific link of the Sharing AP MLD is congested to handle data traffic to be sent to a non-AP MLD due to various implementation dependent reasons. Then, the process 1200 proceeds to S1205.

At S1205, the Sharing AP MLD may select a Shared AP MLD among candidate Share AP MLDs to transfer data traffic, which is supposed to be sent to the non-AP MLD, based on the information received at S1201 from Shared AP MLDs. Then, the process 1200 proceeds to S 1207.

At S1207, the Sharing AP MLD may transfer data traffic, which is supposed to be sent directly to the non-AP MLD, to the Shared AP MLD. Subsequently, the Shared AP MLD may forward the transferred data traffic received from the Sharing AP MLD to the non-AP MLD. Then the process 1200 proceeds to S 1209.

At S1209, the Sharing AP MLD may receive Ack or BlockAck to the transferred data traffic, directly or through the Shared AP MLD, from the non-AP MLD.

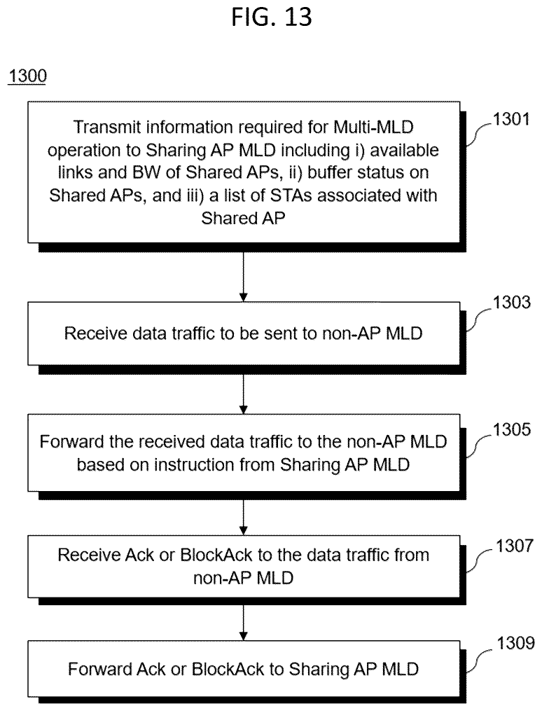

FIG. 13 illustrates a flow chart of an example of a Multi-MLD operation performed by a Shared AP MLD in accordance with an embodiment. For explanatory and illustration purpose, the example process 1300 may be performed by the Shared AP MLDs 1020, 1030, 1120, and 1130. The blocks of the example process 1300 are described herein as occurring in serial or linearly. However, multiple blocks of the example process 1300 may occur in parallel. In addition, the blocks of the example process 1300 need not be performed in the order shown and/or one or more of the blocks/actions of the example process 1300 need not be performed.

At S1301, a Shared AP MLD may transmit information required for Multi-MLD operation set up process to a Sharing AP MLD. This information may include, but not limited to, i) available links and operating bandwidth of Share AP, ii) buffer status on Shared AP, and iii) a list of STAs which are associated with Shared AP.

At S1303, the Shared AP may receive data traffic from the Sharing AP MLD. The data traffic was supposed to be directly sent to a non-AP MLD from the Sharing AP MLD. Then, the process 1300 proceeds to S1305.

At S1305, the Shared AP MLD may forward the received data traffic from the Sharing AP MLD to the non-AP MLD per instruction from the Sharing AP MLD. Then, the process 1300 proceeds to S1307.

At S1307, the Shared AP MLD may receive Ack or BlockAck to the forwarded data traffic from the non-AP MLD. In some embodiment, this operation may not be performed if the non-AP MLD directly sends Ack or Block to the Sharing AP MLD. Then, the process 1300 proceeds to S1309.

At S1309, the Shared AP MLD may forward the received Ack or Block to the Sharing AP MLD. This operation also may not be performed if the non-AP MLD directly sends Ack or BlockAck to the Sharing AP MLD.

To illustrate the interchangeability of hardware and software, items such as the various illustrative blocks, modules, components, methods, operations, instructions, and algorithms have been described generally in terms of their functionality. Whether such functionality is implemented as hardware or software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device for facilitating wireless communication, the AP device comprising:
one or more APs affiliated with the AP device; and
one or more processors coupled to the one or more APs, the one or more processors configured to cause:
receiving setup information from one or more external AP devices, the setup information including at least one available link of at least one AP affiliated with each of the one or more external AP devices;
generating data traffic to be transmitted to a station (STA) affiliated with a non-AP device via a link established between the AP device and the non-AP device;
detecting that the link is not available;
selecting one external AP device among the one or more external AP devices based on the setup information received from the one or more external AP devices; and
transferring the data traffic to the selected external AP device.

2. The AP device of claim 1, wherein the one or more processors are further configured to cause receiving an acknowledgment in response to the transferred data traffic.

3. The AP device of claim 1, wherein the STA affiliated with the non-AP device is associated with an AP affiliated with the selected external AP device.

4. The AP device of claim 1, wherein the setup information further includes buffer status of the at least one AP affiliated with each of the one or more external AP devices.

5. The AP device of claim 1, wherein the setup information further includes a first list of STAs associated with the at least one AP affiliated with each of the one or more external AP devices.

6. The AP device of claim 5, wherein the selecting one external AP device is further based on the first list of STAs and a second list of STAs associated with the AP device.

7. The AP device of claim 2, wherein the acknowledgment is directly received from the non-AP device.

8. The AP device of claim 2, wherein the acknowledgment is received through the selected external AP device from the non-AP device.

9. The AP device of claim 2, wherein the acknowledgment is included in a group addressed frame indicating the AP device and the selected external AP device.

10. The AP device of claim 1, wherein the one or more processors are further configured to cause informing the selected external AP device of a primary channel of the link established between the AP device and the non-AP device.

11. The AP device of claim 1, wherein the one or more processors are further configured to cause transmitting, to the selected external AP device, an address or an identifier of the STA affiliated with the non-AP device.

12. An access point (AP) device for facilitating wireless communication, the AP device comprising:
one or more APs affiliated with the AP device; and
one or more processors coupled to the one or more APs, the one or more processors configured to cause:
transmitting setup information to an external AP device, the setup information including at least one available link of at least one AP affiliated with the AP device;
receiving data traffic, from the external AP device, to be transmitted to a station (STA) affiliated with a non-AP device; and
forwarding the received data traffic to the STA affiliated with the non-AP device.

13. The AP device of claim 12, wherein the one or more processors are further configured to cause:
receiving an acknowledgment from the STA affiliated with the non-AP device; and
forwarding the received acknowledgment to the external AP device.

14. The AP device of claim 12, wherein the STA affiliated with the non-AP device is associated with an AP affiliated with the AP device.

15. The AP device of claim 12, wherein the setup information further includes buffer status of the at least one AP affiliated with the AP device.

16. The AP device of claim 12, wherein the setup information further includes a first list of STAs associated with the at least one AP affiliated with the AP device.

17. The AP device of claim 13, wherein the acknowledgment is included in a group addressed frame indicating the AP device and the external AP device.

18. The AP device of claim 12, wherein the one or more processors are further configured to cause being informed, from the external AP device, of a primary channel of a link established between the external AP device and the non-AP device.

19. The AP device of claim 18, wherein the received data traffic is forwarded to the STA affiliated with the non-AP device through the primary channel informed from the external AP device.

20. The AP device of claim 12, wherein the one or more processors are further configured to cause:
receiving an address or an identifier of the STA affiliated with the non-AP device; and
forwarding the received data traffic to the STA affiliated with the non-AP device using the address or the identifier of the STA affiliated with the non-AP device.
